(19) United States
(12) Patent Application Publication
(10) Pub. No.: US 2020/0158533 A1
(43) Pub. Date: May 21, 2020

(54) STEP-LENGTH CALCULATING DEVICE, PORTABLE TERMINAL, POSITION-INFORMATION PROVIDING SYSTEM, STEP-LENGTH CALCULATING DEVICE CONTROL METHOD, AND PROGRAM

(71) Applicant: SHARP KABUSHIKI KAISHA, Sakai City, Osaka (JP)

(72) Inventors: YOSHIHISA SEKIGUCHI, Sakai City, Osaka (JP); HAJIME KUBOTA, Sakai City, Osaka (JP)

(21) Appl. No.: 16/618,103

(22) PCT Filed: Feb. 21, 2018
(86) PCT No.: PCT/JP2018/006303

§ 371 Date: Nov. 27, 2019

(30) Foreign Application Priority Data
Jun. 1, 2017 (JP) 2017-109288

(51) Int. Cl. G01C 22/00; G01C 21/20

(52) U.S. Cl. CPC G01C 22/00; G01C 21/206

(57) ABSTRACT

A step-length calculating device that calculates a step length of a user without performing complicated processing is realized. A step-length calculating device comprises: a height-difference calculating unit that calculates a height difference of the step-length calculating device at two particular time points by using vertical-direction accelerations of the step-length calculating device, the accelerations being detected by a triaxial acceleration sensor; and a step-length calculating unit that calculates a step length of the user from the height difference and a leg length of the user.

### TECHNICAL FIELD

The present invention relates to a step-length calculating device that calculates the step length of a user by using a detected acceleration.

### BACKGROUND ART

Heretofore, navigation devices that navigate users in subway stations, indoors, and so on have been developed. For example, devices, such as mobile phones, smartphones, and PDAs, comprise the navigation devices. Users can arrive at intended places in underground malls, indoor stores, and so on without getting lost by walking in accordance with guidance information provided from the navigation devices.

In order for the navigation devices to provide detailed guidance information to the users, it is necessary to continually and accurately obtain the positions of users who are moving. A GPS (Global Positioning System) utilizing satellites has already been common as a positioning technology for performing navigation while determining, in real time, the positions of users who are moving. However, with a GPS, in indoors, such as terminal-station buildings and underground malls, it is difficult to receive radio waves from the satellites. Thus, the positions of the users cannot be determined.

Accordingly, in order to realize a device that performs navigation indoors, a technology has been proposed that relatively determines a position in movement of a user by using an acceleration sensor, an angular velocity sensor, a magnetic sensor, and so on. In such a position determination, sensors detect motion (movement variables) of a user who is walking. Also, the traveling direction and the step length of the user who is walking are calculated to calculate motion vectors for respective steps. That is, in order to accurately determine a position in movement of a user, it is necessary to accurately calculate the step length of the user. For example, PTL 1 discloses a technology for realizing step length calculation. Specifically, PTL 1 discloses a device in which a Z-axis acceleration of an acceleration sensor is used to estimate the step length of a user in accordance with a correlation model equation pre-defined according to the walking speed of the user.

### CITATION LIST

### Patent Literature

PTL 1: Japanese Unexamined Patent Application Publication “No. 2014-59315 (published on Apr. 3, 2014)”

### SUMMARY OF INVENTION

### Technical Problem

However, conventional technologies like that described above require processing for setting or obtaining, for each user, the degree of correlation between the step length of the user and an acceleration of up-and-down movement (Z-axis) of the user, the degree of correlation between the step length of the user and the walking speed of the user, and so on, and thus, there is a problem that processing for calculating the step length becomes complicated.

The present invention has been conceived in view of the foregoing problem, and one aspect of the present invention is aimed to realize a step-length calculating device that calculates the step length of a user without performing complicated processing.

### Solution to Problem

In order to overcome the above-described problem, a step-length calculating device according to one aspect of the present invention is a step-length calculating device worn by a user and comprises: an acceleration sensor; a height-difference calculating unit that calculates a height difference of the step-length calculating device at two particular time points by using vertical-direction accelerations of the step-length calculating device, the accelerations being detected by the acceleration sensor; and a step-length calculating unit that calculates a step length of the user from the height difference and a leg length of the user.

In order to overcome the above-described problem, a portable terminal according to one aspect of the present invention comprises: a display unit; a receiving unit that receives, from an external step-length calculating device, information indicating motion vectors for respective steps of a user; a position calculating unit that calculates a position of the user by summing the motion vectors for the respective steps; and a display control unit that displays, in accordance with the calculated position of the user, an image indicating the position of the user on the display unit.

In order to overcome the above-described problem, a control method for a step-length calculating device according to one aspect of the present invention is a control method for a step-length calculating device worn by a user and includes: a height-difference calculating step of calculating a height difference of the step-length calculating device at two particular time points by using vertical-direction accelerations of the step-length calculating device, the accelerations being detected by an acceleration sensor comprised by the step-length calculating device; and a step-length calculating step of calculating a step length of the user from the height difference and a leg length of the user.

### Advantageous Effects of Invention

One aspect of the present invention offers an advantage that the step length of a user can be calculated with simple processing.

### BRIEF DESCRIPTION OF DRAWINGS

FIG. 1 is a block diagram illustrating one example of the configuration of a major portion of a step-length calculating device according to a first embodiment of the present invention.

FIG. 2 is a view illustrating an overview of the step-length calculating device according to the embodiment of the present invention.

FIG. 3 is a diagram illustrating a relationship between walking motion and vertical direction accelerations.

FIG. 4 is a graph illustrating one example of vertical direction accelerations of the step length calculating device according to the first embodiment of the present invention and one example f relative heights calculated from the accelerations.

FIG. 5 is view for describing step length calculation in the step length calculating device according to the first embodiment of the present invention.

FIG. 6 is a graph illustrating results of the step length calculation according to the first embodiment of the present invention.

FIG. 7 is a flowchart illustrating one example of the flow of processing in the step length calculating device according to the first embodiment of the present invention.

FIG. 8 is a diagram illustrating a modification of the configuration of an amplitude calculating unit according to the first embodiment of the present invention.

FIG. 9 is a flowchart illustrating a modification of the flow of the processing in the step-length calculating device according to the first embodiment of the present invention.

FIG. 10 is a view illustrating an overview of a position-information providing system according to a second embodiment of the present invention.

FIG. 11 is a block diagram illustrating one example of the configurations of major portions of the step-length calculating device and a portable terminal according to the second embodiment of the present invention.

FIG. 12 is a block diagram illustrating a modification of the configurations of major portions of the step-length calculating device and the portable terminal according to the second embodiment of the present invention.

FIG. 13 is a view illustrating an overview of a position-information providing system according to a third embodiment of the present invention.

### DESCRIPTION OF EMBODIMENTS

### First Embodiment

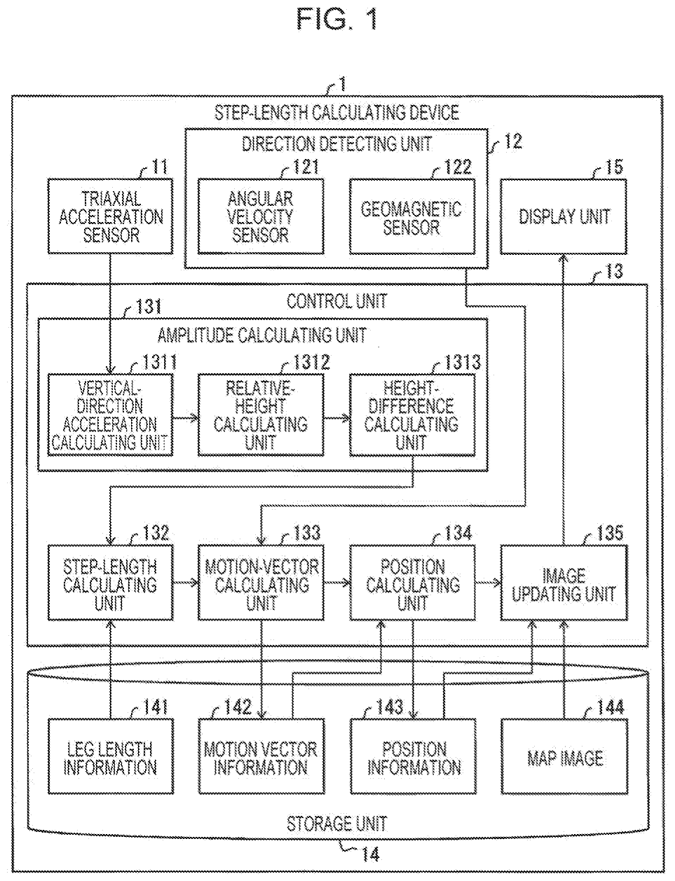

Embodiments of the present invention will be described below in detail with reference to FIGS. 1 to 6.

(Overview of Step-Length Calculating Device 1)

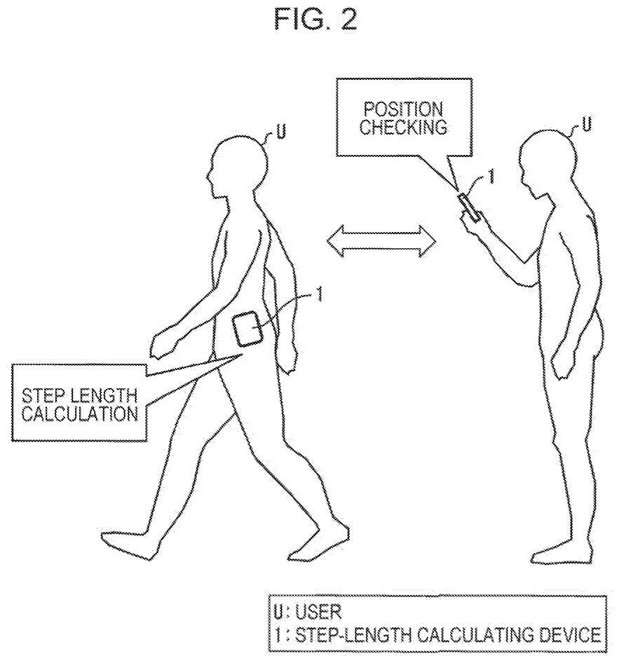

First, an overview of a step-length calculating device 1 according to the present embodiment will be described with reference to FIG. 2. FIG. 2 is a view illustrating an overview of the step-length calculating device 1. As illustrated in FIG. 2, the step-length calculating device 1 is worn at a position above the waist (a portion above the groin area) of a user. The step-length calculating device 1 detects vertical-direction accelerations and uses the accelerations to calculate a height difference of the step-length calculating device 1 at two time points. The step-length calculating device 1 calculates a step length of the user from the calculated height difference and the leg length of the user. In addition, the step-length calculating device 1 senses a traveling direction of the user. The step-length calculating device 1 calculates motion vectors of the user from the calculated step length and the detected traveling direction and utilizes the motion vectors to calculate the current position of the user. The step-length calculating device 1 then displays the current position of the user. The user can check his or her position by checking the position displayed by the step-length calculating device 1. The step-length calculating device 1 may be, for example, a tablet-type terminal, a smartphone, or the like, but is not particularly limiting. According to the above-described configuration, it is possible to realize an indoor navigation device and so on.

(Configuration of Step-Length Calculating Device 1)

Next, the configuration of the step-length calculating device 1 will be described with reference to FIG. 1. FIG. 1 is a block diagram illustrating the configuration of a major portion of the step-length calculating device 1. As illustrated in FIG. 1, the step-length calculating device 1 comprises a triaxial acceleration sensor (an acceleration sensor) 11, a direction detecting unit 12, a control unit 13, a storage unit 14, and a display unit 15.

(Triaxial Acceleration Sensor 11)

The triaxial acceleration sensor 11 detects accelerations for respective axial directions of direction axes (an X-axis, Y- and Z-axes) indicating an orthogonal coordinate systems in three-dimensional space. The triaxial acceleration sensor 11 sends the detected accelerations to an amplitude calculating unit 131 in the control unit 13.

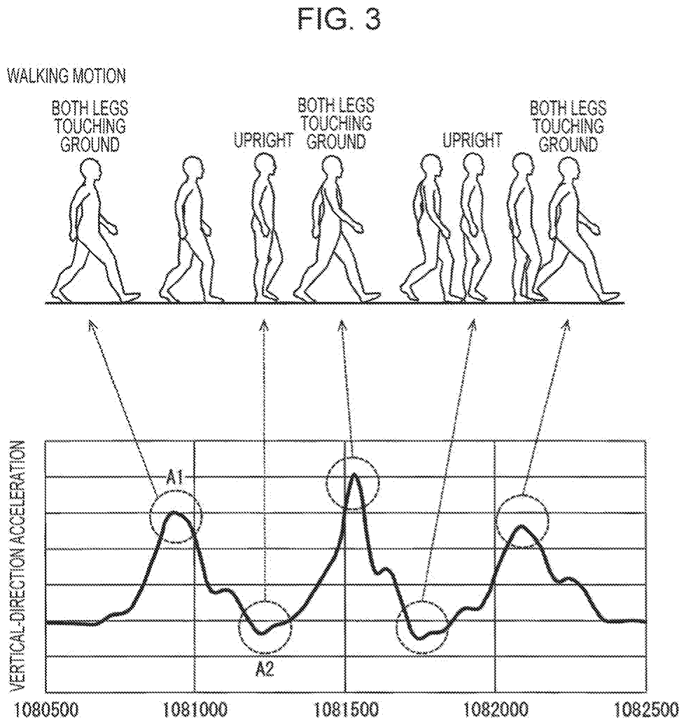

Now, a relationship between walking motion and up-and-down movement accelerations (vertical-direction accelerations) of a walking person will be described using FIG. 3. FIG. 3 is a diagram illustrating a relationship between walking motion and up-and-down movement accelerations of a walking person. In walking motion of the human, the height of the waist moves up and down. The height of the waist is the lowest when both feet are contacting the ground surface (both feet are touching the around). Also, while the human is moving one of the legs forward, the height of the waist is the highest when the leg contacting the ground surface is vertically upright (both feet align). Also, as illustrated in FIG. 3, the up-and-down movement acceleration of the walking person varies in the walking motion. The acceleration increases at a time point when both feet of the walking person contact the ground, and the acceleration decreases at a time point when both feet of the walking person align (upright). In other words, in variations in the up-and-down movement acceleration of the walking person, the acceleration reaches its upper-end peak at the time point when both feet of the walking person touch the ground. Also, the acceleration reaches its lower-end peak at the time point when both feet of the walking person align (upright). A1 illustrated in FIG. 3 indicates the acceleration (the upper-end peak) at the time point when both feet of the walking person touch the ground. Also, A2 illustrated in FIG. 3 indicates the acceleration (the lower-end peak) at the time point when both feet of the walking person touch the ground.

(Direction Detecting Unit 12)

The direction detecting unit 12 detects the direction of walking of the user. The direction detecting unit 12 comprises, for example, at least one of an angular velocity sensor (a sensor for detecting a walking direction) 121 and a geomagnetic sensor (a sensor for detecting a walking direction) 122. The direction detecting unit 12 sends detection values of at least one of the angular velocity sensor 121 and the geomagnetic sensor 122 to a motion-vector calculating unit 133.

(Control Unit 13)

The control unit 13 performs overall control on the individual units in the step-length calculating device 1. The control unit 13 comprises an amplitude calculating unit 131, a step-length calculating unit 132, the motion-vector calculating unit 133, a position calculating unit 134, and an image updating unit (a display control unit) 135.

(Amplitude Calculating Unit 131)

The amplitude calculating unit 131 calculates the amplitude of a height of the step-length calculating device 1. The amplitude calculating unit 131 comprises a vertical-direction acceleration calculating unit (an acceleration calculating unit) 1311, a relative-height calculating unit 1312, and a height-difference calculating unit 1313.

(Vertical-Direction Acceleration Calculating Unit 1311)

The vertical-direction acceleration calculating unit 1311 calculates vertical-direction accelerations from detection values of the triaxial acceleration sensor 11. For example, the axial direction of a particular axis (Z-axis) of the triaxial acceleration sensor 11 does not always become the same as the vertical direction, depending on the orientation of the step-length calculating device 1. Thus, the vertical-direction acceleration calculating unit 1311 calculates the orientation of the step-length calculating device 1 by utilizing the gravitational acceleration always working in the vertical direction at about 9.8 G. The vertical-direction acceleration calculating unit 1311 calculates the vertical-direction accelerations of the step-length calculating device 1 from the detection values of the triaxial acceleration sensor 11 through matrix computation or the like according to the calculated orientation of the step-length calculating device 1. The vertical-direction acceleration calculating unit 1311 sends the calculated vertical-direction accelerations to the relative-height calculating unit 1312. Of three orthogonal axis accelerations detected by the triaxial acceleration sensor, the accelerations in a Z-axis direction may be used as the vertical-direction accelerations. In the case of this configuration, the triaxial acceleration sensor 11 may send the detected Z-axis direction accelerations to the relative-height calculating unit 1312.

(Relative-Height Calculating Unit 1312)

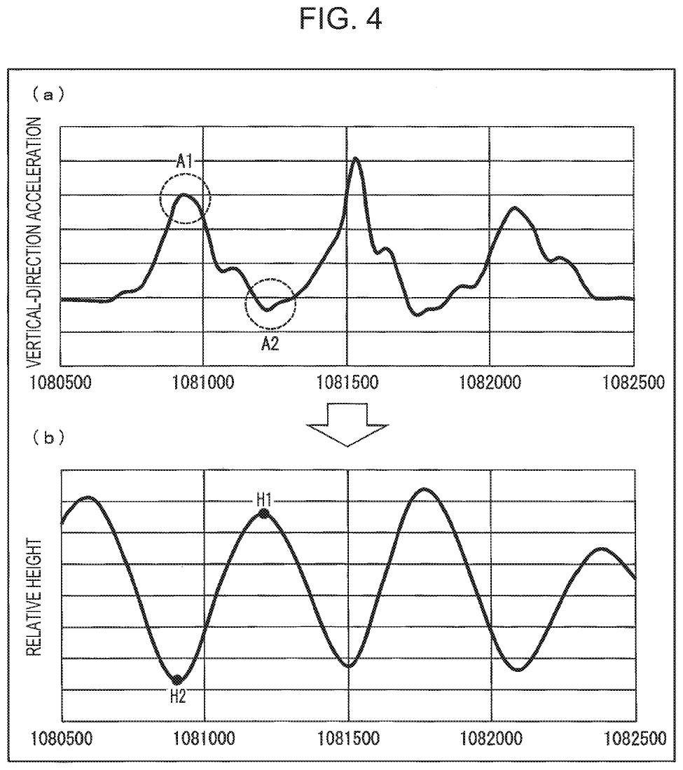

The relative-height calculating unit 1312 integrates the received vertical-direction accelerations to calculate relative heights, which are the heights of the step-length calculating device relative to a predetermined height. One example of the calculation of the relative heights of the step-length calculating device 1, the calculation being performed by the relative-height calculating unit 1312, will be described using FIG. 3. FIG. 4 is a graph illustrating the vertical-direction accelerations of the step-length calculating device and the relative heights calculated from the acceleration. (a) in FIG. 4 illustrates one example of the vertical-direction accelerations of the step-length calculating device 1. (b) in FIG. 4 illustrates the relative heights of the step-length calculating device 1, the relative heights being calculated from the vertical-direction accelerations. The relative-height calculating unit 1312 calculates the relative heights by performing double integration on the vertical-direction accelerations at respective time points. The relative-height calculating unit 1312 sends the calculated relative heights to the height-difference calculating unit 1313. The predetermined height that serves as a reference of the relative heights may be the height of the step-length calculating device 1 at a time point when the step length calculation processing performed by the step-length calculating device 1 is started.

(Height-Difference Calculating Unit 1313)

The height-difference calculating unit 1313 calculates a height difference of the step-length calculating device 1 at two particular time points by using the vertical-direction accelerations of the step-length calculating device, the accelerations being detected by the acceleration sensor.

Specifically, the height-difference calculating unit 1313 calculates the height difference of the step-length calculating device 1 at two particular time points by using the relative heights received from the relative-height calculating unit 1312.

Also, in the present embodiment, the aforementioned two particular time points are time points at which the height of the step-length calculating device 1 reaches an upper-end peak and reaches a lower-end peak in the amplitude of variations in the height of the step-length calculating device 1 in a predetermined period. That is, the height-difference calculating unit 1313 detects the lower-end peak (valley) and the upper-end peak (mountain) in a waveform representing the relative heights of the step-length calculating device 1. A description will be specifically given with reference in FIG. 4. As illustrated in (b) in FIG. 4, the height-difference calculating unit 1313 calculates the height difference between a height H1 of the upper-end peak and a height H2 of the lower-end peak which are adjacent to each other in variations in the height of the step-length calculating device 1. The above-described predetermined period can be said to be a period including a time point at which the height of the step-length calculating device 1 reaches the upper-end peak and a time point at which the height of the step-length calculating device 1 reaches the lower-end peak. The height-difference calculating unit 1313 sends the calculated height difference of the steep-length calculating device 1 to the step-length calculating unit 132.

(Step-Length Calculating Unit 132)

The step-length calculating unit 132 calculates a step length of the user from the height difference of the step-length calculating device 1, the height difference being received from the height-difference calculating unit 1313, and the leg length of the user. For example, as illustrated in FIG. 2, the step-length calculating unit 132 refers to leg length information. 141, which is information stored in the storage unit 14 and indicating the leg length of the user. The step-length calculating unit 132 sends the calculated step length to the motion-vector calculating unit 133.

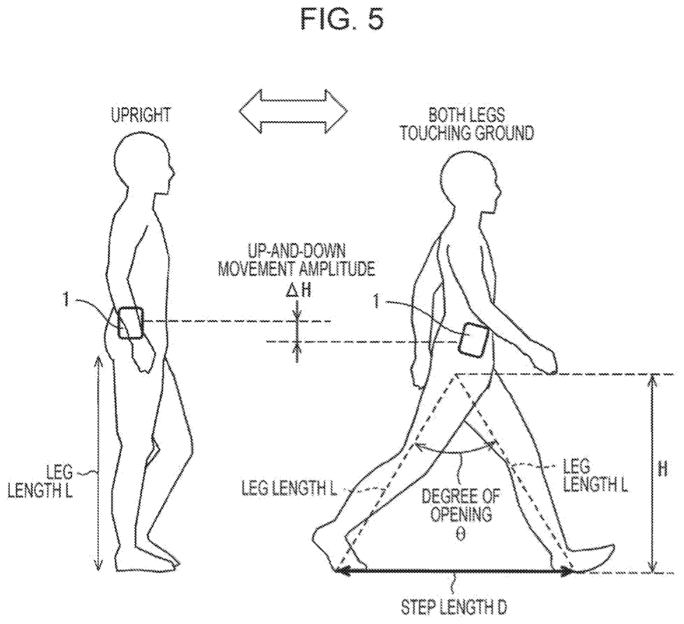

Now, details of the step length calculation in the step-length calculating unit 132 will be described with reference to FIG. 5. FIG. 5 is a drawing for describing the step length calculation executed by the step-length calculating unit 132. As illustrated in FIG. 5, when both feet are touching the ground in walking motion, an isosceles triangle is formed in which both feet are two sides thereof and the step length is the base thereof. As illustrated in FIG. 5, the height of the isosceles triangle is denoted by H, the base length (the step length) is denoted by D, the side length (the leg length) formed by both feet is denoted by L, and the angle indicating the degree of opening of the legs is denoted by θ.

The height H of the isosceles triangle can be calculated according to mathematical expression 1 below. Also, the base length (the step length) D can be calculated according to mathematical expression 2 below.

$$\begin{matrix}[ Eq . 1 ] & \\ H = L cos ( \frac{Θ}{2} ) & Mathematical Expression ( 1 ) \\ [ Eq . 2 ] & \\ D = 2 L sin ( \frac{Θ}{2} ) & Mathematical Expression ( 2 )\end{matrix}$$

Also, ΔH, which is the amplitude of up-and-down variations in the position of the step-length calculating device 1, can be calculated according to mathematical expression 3 below (the height difference of the step-length calculating device 1 at two particular time points; the difference between the upper-end peak and the lower-end peak of the relative heights).

$$\begin{matrix}[ Eq . 3 ] & \\ Δ H = L - L cos ( \frac{Θ}{2} ) & Mathematical Expression ( 3 )\end{matrix}$$

From mathematical expression 2 and mathematical expression 3, the step length D can also be calculated according to mathematical expression 4 below.

[Eq. 4]

D=2{square root over (∠H(2L−∠)}H) Mathematical Expression 4)

That is, the step length D can be calculated from the height difference ΔH of the step-length calculating device 1 and the leg length L of the walking person. The step-length calculating unit 132 calculates the step length by using mathematical expression 4 noted above. Accordingly, the step-length calculating unit 132 can calculate the step length of a user who wears the step-length calculating device 1 above the waist position (the groin area). For example, the height H of the isosceles triangle decreases as the leg opening increases. Thus, when the legs are widely opened, that is, when the step length increases, the height difference ΔH increases. In other words, the step-length calculating unit 132 calculates a larger step length for a larger leg opening of the user. The step-length calculating unit 132 may determine the extent of lea opening for each step of the user from the height difference ΔH. In this configuration, the step-length calculating unit 132 calculates a larger step length as the determined extent of leg opening becomes larger. The leg length L is generally proportional to the height. Thus, the step-length calculating unit 132 may use the height as a parameter for the step length calculation.

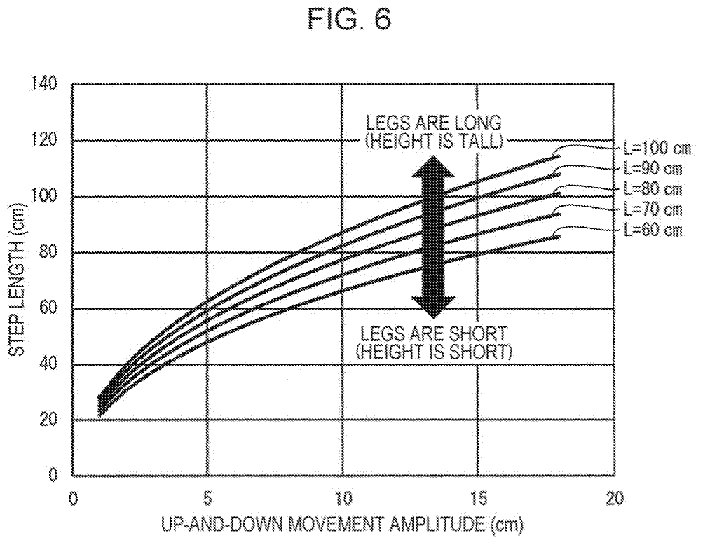

Also, step lengths for different leg lengths were calculated using mathematical expression 4 noted above. FIG. 6 is a graph illustrating the step lengths calculated according to mathematical expression 4 noted above. The vertical axis represents the calculated step lengths (cm), and the horizontal axis represents the height differences ΔH (the up-and-down movement amplitude (cm)) of the step-length calculating device 1. As illustrated in FIG. 6, when mathematical expression 4 is used, even if the height differences ΔH have the same value, the larger the leg length is, the larger the step length D that is calculated is. That is, the step-length calculating unit 132 calculates a larger step length for a larger leg length of the user.

According to the configuration in the present embodiment in which the step length is calculated according to mathematical expression 4, the processing for detecting or calculating a walking speed of the user is not needed in order to calculate the step length of the user. Meanwhile, in a configuration in which the walking speed is calculated in order to calculate the step length, the configuration being different from the present embodiment, it is necessary to integrate the accelerations in the direction of movement from when the user is standing still. In such a configuration, when the user continues to move, when detection of stopping of the movement of the user becomes ambiguous, or the like, error in a step length that, is calculated increases. Accordingly, there is a possibility that the accuracy of the step length that is calculated decreases significantly. According to the configuration in the present embodiment, since the step length of the user does not need to be calculated in order to calculate the walking speed of the user, ii is possible to perform high-accuracy step length calculation.

(Motion-Vector Calculating Unit 133)

The motion-vector calculating unit 133 calculates motion vectors for respective steps of the user in accordance with detection values of at least one of the angular velocity sensor 121 and the geomagnetic sensor 122 comprised by the direction detecting unit 12 and the calculated step length of the user. The motion-vector calculating unit 133 stores motion vector information 142, which indicates the calculated motion vectors, in the storage unit 14 and sends a signal indicating that the motion vector information 142 is stored to the position calculating unit 134.

(Position Calculating Unit 134)

The position calculating unit 134 calculates the position of the user by summing the motion vectors for the respective steps. The position calculating unit 134 stores position information 143, which is information indicating the calculated position of the user, in the storage unit 14 and sends a signal indicating that the position information 143 is stored to the image updating unit 135.

(Image Updating Unit 135)

Upon receiving the signal indicating that the position information 143 is stored in the storage unit 14 from the position calculating unit 134, the image updating unit 135 refers to the position information 143 to update (generate) an image indicating the position of the user. The image updating unit 135 displays the updated image on the display unit 15. For example, the image updating unit 135 may use a map image 144, which is an image of an indoor map or the like stored in the storage unit 14, to generate an image indicating the position of the user.

(Storage Unit 14)

The storage unit 14 stores the above-described leg length information 141, the motion vector information 142, the position information 143, and the map image 144 therein.

(Display Unit 15)

The display unit 15 has a display screen for displaying image data, receives an image signal from the control unit 13, and displays an image on the display screen on the basis of the received image signal. The display unit 15 may be any display unit comprising a function for displaying images and may also be constituted by, for example, an LCD (Liquid Crystal Display) display device, an EL (Electro Luminescence) display device, or the like. Also, the display unit 15 may be disposed on a touch panel, and the touch panel may receive a touch operation of the user with respect to the display screen. For example, the step-length calculating device 1 may start the step length calculation processing on the basis of the user's instruction for starting the processing, the instruction being received from the touch panel.

(Flow of Processing in Step-Length Calculating Device 1)

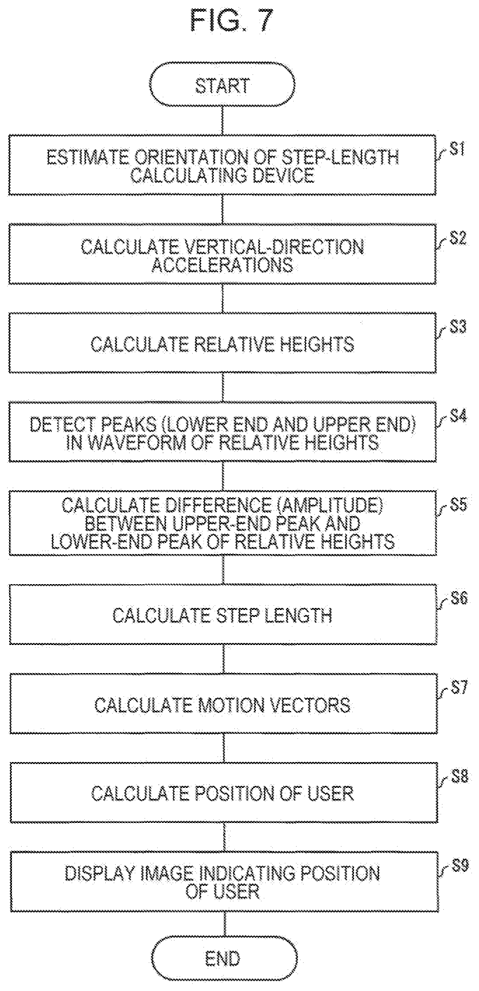

Next, processing in the step-length calculating device 1 will be described with reference to FIG. 7. FIG. 7 is a flowchart illustrating one example of the flow of processing executed by the step-length calculating device 1. For example, upon receiving a start operation performed by the user, the step-length calculating device 1 starts the processing. The vertical-direction acceleration calculating unit 1311 calculates the orientation of the step-length calculating device 1 (S1) and calculates vertical-direction accelerations of the step-length calculating device 1 (S2). Subsequently, the relative-height calculating unit 1312 calculates relative heights of the step-length calculating device by using the vertical-direction accelerations of the step-length calculating device 1 (S3). Subsequently, the height-difference calculating unit 1313 detects the lower-end peak (valley) and the upper-end peak (mountain) in a waveform indicating the relative heights of the step-length calculating device 1 (S4). Subsequently, the height-difference calculating unit 1313 calculates the difference between the lower-end peak of the relative heights and the upper-end peak thereof as the height difference of the step-length calculating device 1 (S5: a height-difference calculating step). Subsequently, the step-length calculating unit 132 calculates the step length from the height difference and the leg length of the user (S6: a step-length calculating step). Subsequently, the motion-vector calculating unit 133 calculates motion vectors for respective steps of the user from the detection values of the direction detecting unit 12 and the calculated step length (S7). The position calculating unit 134 sums the motion vectors for the respective steps to calculate the position of the user (S8). Subsequently, the image updating unit 135 updates (generates) an image indicating the position of the user and displays the image on the display unit 15 (S9). For example, the step-length calculating device 1 receives an end operation performed by the user and ends the processing. When the step-length calculating device 1 does not receive the end operation performed by the user, the flow returns to S1.

(Modification)

(Configuration of Amplitude Calculating Unit 131a)

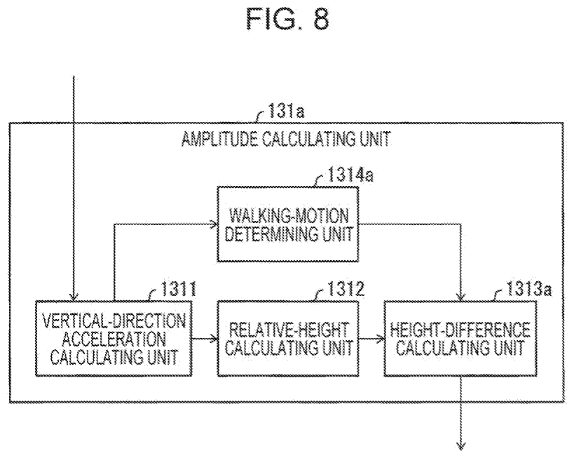

Next, an amplitude calculating unit 131a according to this modification will be described with reference to FIGS. 3 and 8. FIG. 8 is diagram illustrating the configuration of the amplitude calculating unit 131a according to this modification.

The amplitude calculating unit 131a comprises a vertical-direction acceleration calculating unit 1311, a relative-height calculating unit 1312, a height-difference calculating unit 1313a, and a walking-motion determining unit 1314a. Since the configurations of the vertical-direction acceleration calculating unit 1311 and the relative-height calculating unit 1312 are analogous to the configurations described above, descriptions thereof are omitted here.

(Walking-Motion Determining Unit 1314a)

In accordance with detection values detected by the triaxial acceleration sensor, the walking-motion determining unit 1314a determines a time point at which both feet align in walking motion of the user and a time point at which both feet touch the ground in the walking motion of the user. Specifically, the walking-motion determining unit 1314a receives vertical-direction accelerations of the step-length calculating device 1 from the vertical-direction acceleration calculating unit 1311 and uses the accelerations to determine a time point at which both feet align and a time point at which both feet of the user touch the ground. The walking-motion determining unit 1314a sends the determined time points to the height-difference calculating unit 1313a.

The processing in the walking-motion determining unit 1314a will be described in more detail. As illustrated in FIG. 3, the vertical-direction acceleration of the step-length calculating device 1 becomes large at a time point at which both feet of the user touch the ground and becomes small at a time point at which both feet of the user align (upright). The walking-motion determining unit 1314a determines that the time point at which both feet of the user touch the ground is a time point at which the acceleration reaches the upper-end peak (A1 in FIG. 3) in a waveform of variations in the vertical-direction acceleration of the step-length calculating device 1. Also, the walking-motion determining unit 1314a determines that the time point at which both feet of the user align is a time point at which the acceleration reaches the lower-end peak (A2 in FIG. 3) in the waveform of variations in the vertical-direction acceleration of the step-length calculating device 1.

(Height-Difference Calculating Unit 1313a)

The height-difference calculating unit 1313a calculates the height difference of the step-length calculating device 1 at two particular time points by using the relative heights received from the relative-height calculating unit 1312. That is, in this modification, the two particular time points are a time point at which both feet of the user align and a time point at which both feet of the user touch the ground in a predetermined period. The height-difference calculating unit 1313 sends the calculated height difference of the step-length calculating device 1 to the step-length calculating unit 132.

(Flow of Processing in Step-Length Calculating Device 1: Modification)

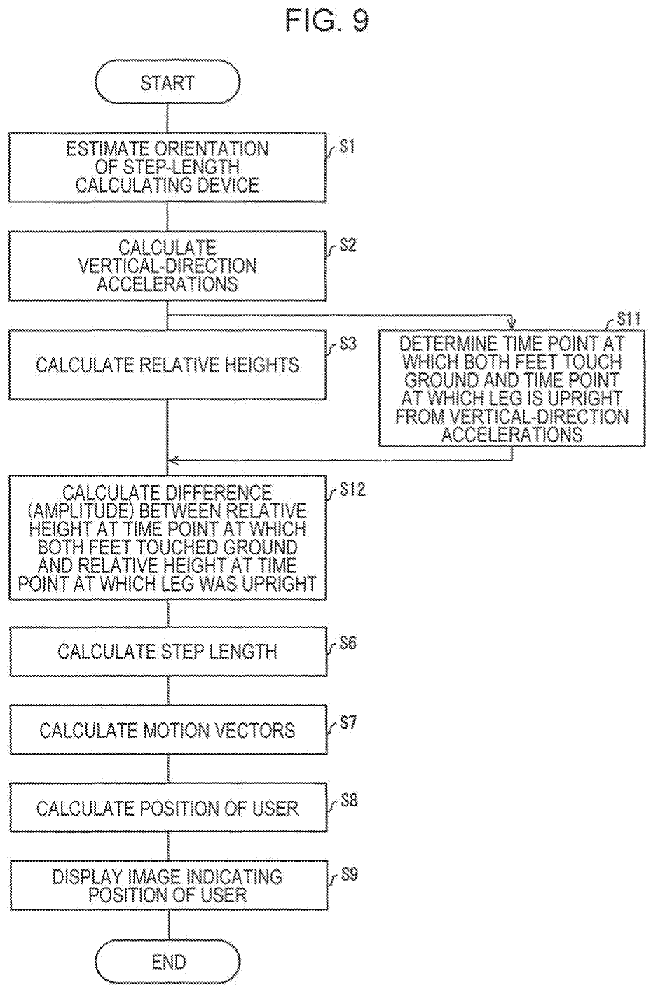

Next, a modification of the processing in the step-length calculating device 1 will be described with reference to FIG. 9. FIG. 9 is a flowchart illustrating a modification of the flow of the processing executed by the step-length calculating device 1. Since S1 to S3 and S6 to 59 are analogous to the processes described above, descriptions thereof are omitted here. The walking-motion determining unit 1314a determines a time point at which both feet of the user align and a time point at which both feet of the user touch the ground from the vertical-direction accelerations of the step-length calculating device 1 and in accordance with the accelerations (S11). Subsequently, the height-difference calculating unit 1313a calculates the height difference between a relative height at the time point at which both feet of the user aligned and a relative height at the time point at which both feet of the user touched the ground (S12: a height-difference calculating step).

### Second Embodiment

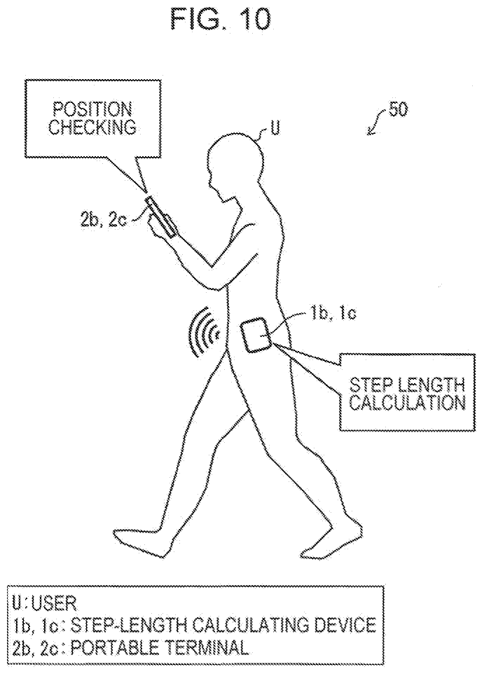

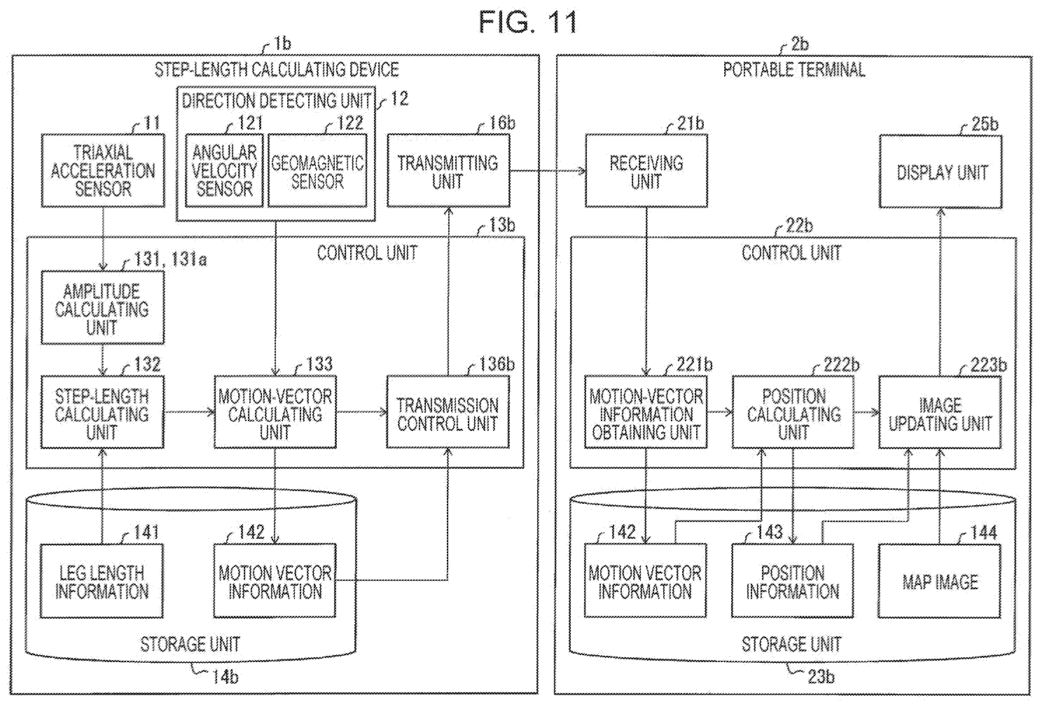

Another embodiment of the present invention will be described based on FIGS. 10 and 11, as follows. For convenience of description, members having the same functions as the members described in the above embodiment are denoted by the same reference numerals, and decryptions thereof are omitted.

(Overview of Position-Information Providing System 50)

FIG. 10 is a view illustrating an overview of a position-information providing system 50 according to the present embodiment. As illustrated in FIG. 10, in the position-information providing system 50, a step-length calculating device 1b calculates the step length of the user and transmits motion vector information 142 indicating motion vectors to a portable terminal (external equipment) 2b. Also, in a modification of the present embodiment, a step-length calculating device 1c calculates the step length of the user and transmits motion vector information 142, which is information indicating the position of the user, to a portable terminal (external equipment) 2c. The portable terminal 2b and the portable terminal 2c display images indicating the position of the user.

(Configuration of Step-Length Calculating Device 1b)

The configuration of the step-length calculating device 1b according to the present embodiment will be described with reference to FIG. 11. FIG. 11 is a block diagram illustrating the configurations of major portions of the step-length calculating device 1b and the portable terminal 2b. As illustrated in FIG. 11, the step-length calculating device 1b comprises a triaxial acceleration sensor 11, a direction detecting unit 12, a control unit 13b, a storage unit 14b, and a transmitting unit 16b. Since the configurations of the triaxial acceleration sensor 11 and the direction detecting unit 12 are analogous to the configurations described in the first embodiment, descriptions thereof are omitted here.

(Control Unit 13b)

The control unit 13b comprises an amplitude calculating unit 131, a step-length calculating unit 132, a motion-vector calculating unit 133, and a transmission control unit 136b. The control unit 13b may also comprise the amplitude calculating unit 131a, instead of the amplitude calculating unit 131. Since the configurations of the amplitude calculating unit 131, the step-length calculating unit 132, and the motion and motion-vector calculating unit 133 are analogous to the configurations described in the first embodiment, descriptions thereof are omitted here.

(Transmission Control Unit 136b)

The transmission control unit 136b transmits the motion vector information 142, which indicates motion vectors, to the portable terminal 2b, which is external equipment.

Specifically, the transmission control unit 136b receives a signal indicating that the motion vector information 142 is stored in the storage unit 14b from the motion-vector calculating unit 133. The transmission control unit 136b transmits the motion vector information 142, stored in the storage unit 14b, to the portable terminal 2b via the transmitting unit 16b.

(Transmitting Unit 16b)

The transmitting unit 16b transmits data to external equipment. In particular, in the present embodiment, the transmitting unit 16b transmits the motion vector information 142 to the portable terminal 2 in accordance with an instruction of the transmission control unit 136b. The transmitting unit 16b may employ, for example, short distance radio, such as Bluetooth (registered trademark).

(Storage Unit 14b)

The storage unit 14b stores the leg length information 141 and the motion vector information 142 therein.

(Configuration of Portable Terminal 2b)

Next, the configuration of the portable terminal 2b according to the present embodiment will be described with reference to FIG. 11. As illustrated in FIG. 11, the portable terminal 2b comprises a receiving unit 21b, a control unit 22b, a storage unit 23b, and a display unit 25b. The portable terminal 2b may be, for example, a tablet-type terminal, a smartphone, or the like. Since the configuration of the display unit 25b is analogous to the display unit 15 described above, a description thereof is omitted here.

(Receiving Unit 21b)

The receiving unit 21b receives data from external equipment. In particular, in the present embodiment, the receiving unit 21b receives the motion vector information 142, which is information indicating motion vectors for respective steps of the user, from the step-length calculating device 1b, which is external equipment. The receiving unit 21b sends the motion vector information 142 to a motion-vector information obtaining unit 221b.

(Control Unit 22b)

The control unit 22b comprises a motion-vector information obtaining unit 221b, a position calculating unit 222b, and an image updating unit (a display control unit) 223b.

(Motion-Vector Information Obtaining Unit 221b)

The motion-vector information obtaining unit 221b stores the received motion vector information 142 in the storage unit 23b. The motion-vector information obtaining unit 221b sends a signal indicating that the motion vector information 142 is stored in the storage unit 23b to the position calculating unit 222b.

(Position Calculating Unit 222b)

The position calculating unit 222b sums the motion vectors for respective steps to calculate the position of the user. The position calculating unit 222b stores position information 143, which is information indicating the calculated position of the user, in the storage unit 23b and sends a signal indicating that the position information 143 is stored to the image updating unit 223b.

(Image Updating Unit 223b)

The image updating unit 223b displays an image indicating the position of the user on the display unit 25b in accordance with the position information 143. Since details of the image updating unit 223b are analogous to the image updating unit 135 described above, descriptions thereof are omitted here.

(Storage Unit 23b)

The storage unit 23b stores the motion vector information 142, the position information 143, and a map image 144 therein.

Detection values of a sensor comprised by the direction detecting unit 12 and the triaxial acceleration sensor 11 which are worn by the user may be transmitted to the portable terminal 2b, such as a tablet, a smartphone, or the like, and the portable terminal 2b may perform processing, such as the step length calculation, the position information calculation, and so on described above.

(Modification)

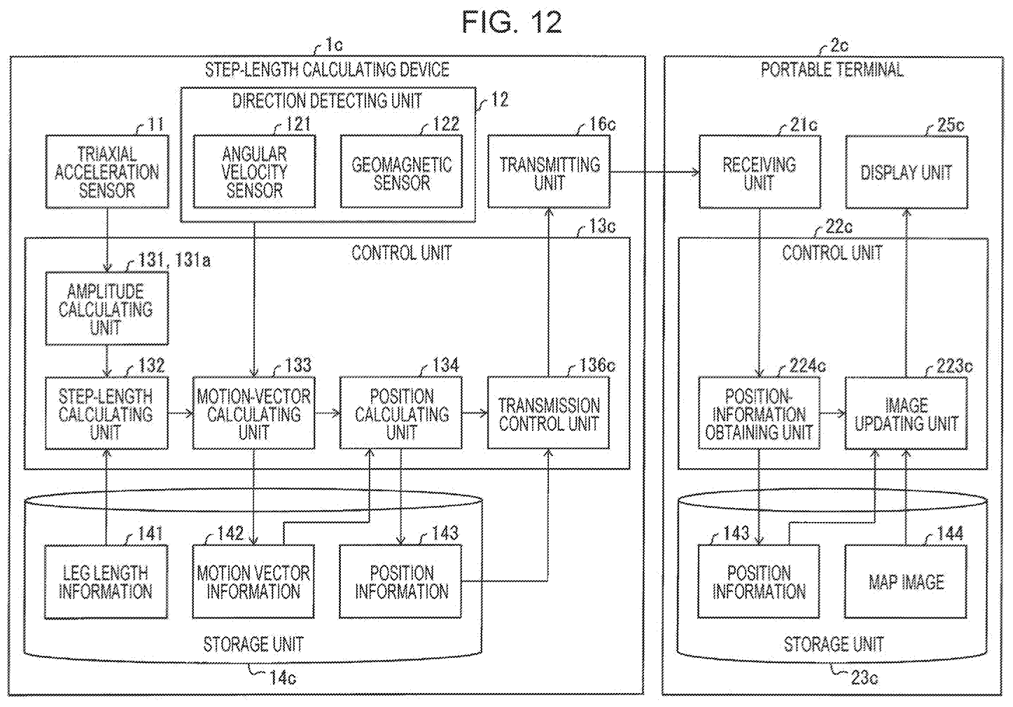

Next, the configuration of the step-length calculating device 1c according to this modification will be described with reference to FIG. 12. FIG. 12 is a block diagram illustrating the configurations of major portions of the step-length calculating device 1c and the portable terminal 2c. As illustrated in FIG. 12, the step-length calculating device 1c comprises a triaxial acceleration sensor 11, a direction detecting unit 12, a control unit 13c, a storage unit 14c, and a transmitting unit 16c. Since the configurations of the triaxial acceleration sensor 11 and the direction detecting unit 12 are analogous to the configurations described in the first embodiment, descriptions thereof are omitted here.

(Control Unit 13c)

The control unit 13c comprises an amplitude calculating unit 131, a step-length calculating unit 132, a motion-vector calculating unit 133, a position calculating unit 134, and a transmission control unit 136c. Since the configurations of the amplitude calculating unit 131, the step-length calculating unit 132, the motion-vector calculating unit 133, and the position calculating unit 134 are analogous to the configurations described in the first embodiment, descriptions thereof are omitted here. The control unit 13c may also comprise the amplitude calculating unit 131a instead of the amplitude calculating unit 131.

(Transmission Control Unit 136c)

The transmission control unit 136c transmits the position information 143, which indicates information indicating the position of the user, to the portable terminal 2c, which is external equipment.

Specifically, the transmission control unit 136c receives a signal indicating that the position information 143 is stored in the storage unit 14c from the position calculating unit 134. The transmission control unit 136c transmits the position information 143, stored in the storage unit 14c, to the portable terminal 2c via the transmitting unit 16c.

(Transmitting Unit 16c)

The transmitting unit 16c transmits the position information 143 to the portable terminal 2 in accordance with an instruction of the transmission control unit 136c. The transmitting unit 16c may employ, for example, short distance radio, such as Bluetooth.

(Storage Unit 14c)

The storage unit 14c stores the leg length information 141, the motion vector information 142, and the position information 143 therein.

(Configuration of Portable terminal 2c)

Next, the configuration of the portable terminal 2c according to the present embodiment will be described with reference to FIG. 12. As illustrated in FIG. 12, the portable terminal 2c comprises a receiving unit 21c, a control unit 22c, a storage unit 23c, and a display unit 25c. Examples of the portable terminal 2c include a tablet-type terminal, a smartphone, and so on. Since the configuration of the display unit 25c is analogous to the display unit 15 described above, a description thereof is omitted here.

(Receiving Unit 21c)

The receiving unit 21c receives data from external equipment. In particular, in the present embodiment, the receiving unit 21c receives the position information 143, which is information indicating the position of the user, from the step-length calculating device 1c, which is external equipment. The receiving unit 21c sends the position information 143 to a position-information obtaining unit 224c.

(Control Unit 22c)

The control unit 22c comprises a position-information obtaining unit 224c and an image updating unit (a display control unit) 223c.

(Position-Information Obtaining Unit 224c)

The position-information obtaining unit 224c stores the received position information 143 in the storage unit 23c. The position-information obtaining unit 224c sends a signal indicating that the position information 143 is stored in the storage unit 23c to the image updating unit 223c.

(Image Updating Unit 223c)

The image updating unit 223c displays an image indicating the position of the user on the display unit 25c in accordance with the position information 143. Since details of the image updating unit 223c are analogous to the image updating unit 135 described above, descriptions thereof are omitted here.

(Storage Unit 23c)

The storage unit 23b stores the position information 143 and the map image 144 therein.

### Third Embodiment

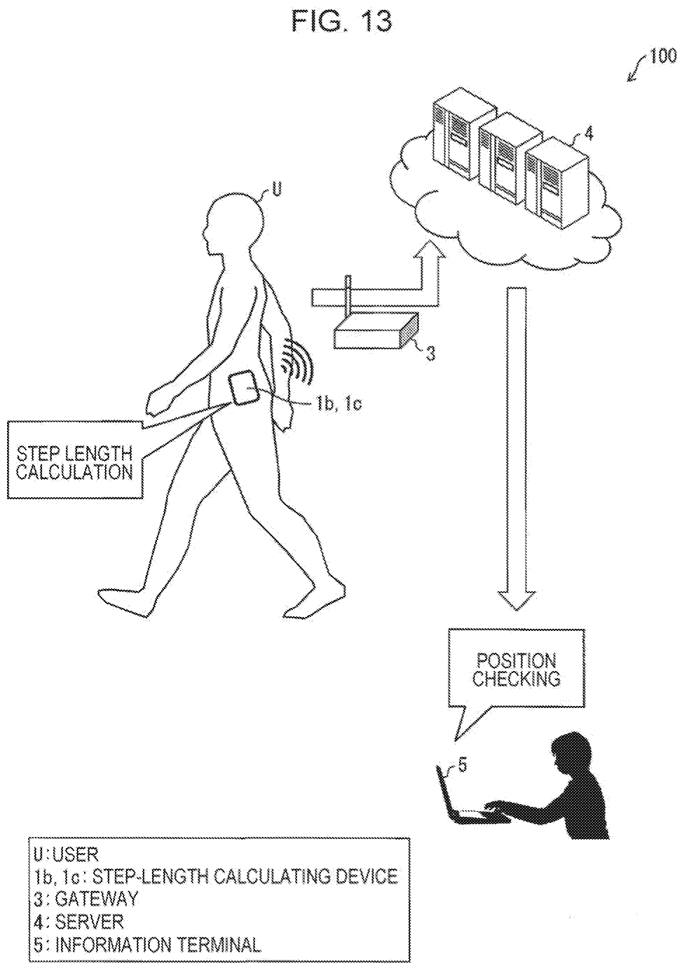

Another embodiment of the present invention will be described based on FIG. 13, as follows. For convenience of description, members having the same functions as the members described in the above embodiments are denoted by the same reference numerals, and decryptions thereof are omitted.

(Overview of Position-Information Providing System 100)

FIG. 13 is a view illustrating an overview of a position-information providing system 100 according to the present embodiment. As illustrated in FIG. 13, the position-information providing system 100 includes a step-length calculating device 1b or a step-length calculating device 1c, a gateway 3, a server 4, and an information terminal 5. Since the step-length calculating device 1b and the step-length calculating device 1c have been described in the second embodiment in detail, descriptions thereof are omitted here.

### Example 1 of Position-Information Providing System

First, a description will be given of the position-information providing system 100 including the step-length calculating device 1b.

The gateway 3 receives the motion vector information 142 from the step-length calculating device 1b. Communication of the motion vector information 142 between the step-length calculating device 1b and the gateway 3 may employ short distance radio, such as Bluetooth.

The server 4 is, for example, a cloud server and communicates with the gateway 3. The information terminal 5 comprises a display unit and receives the position information 143 from the server 4. The information terminal 5 is, a PC, a tablet-type terminal, a smartphone, or the like.

Any one of the gateway 3 and the server 4 sums the motion vector information 142 to calculate the position information 143. In the configuration in which the gateway 3 calculates the position information 143, the gateway 3 transmits the position information 143 to the server 4. Also, in the configuration in which the server 4 calculates the position information 143, the gateway 3 transmits the motion vector information 142 to the server 4.

The information terminal 5 receives the calculated position information 143 and displays an image, which indicates the position of the user who wears the step-length calculating device 1b, on the display unit in accordance with the information.

### Example 2 of Position-Information Providing System

Next, a description will be given of the position-information providing system 100 including the step-length calculating device 1c.

The gateway 3 receives the position information 143 from the step-length calculating device 1b. Communication of the position information 143 between the step-length calculating device 1c and the gateway 3 may employ short distance radio, such as Bluetooth.

The server 4 is, for example, a cloud server and receives the position information 143 from the gateway 3. The information terminal 5 comprises a display unit and receives the position information 143 from the server 4. The information terminal 5 is a PC, a tablet-type terminal, a smartphone, or the like.

The information terminal 5 receives the position information 143 and displays an image, which indicates the position of the user who wears the step-length calculating device 1c, on the display unit in accordance with the information.

The configuration may be such that any one of the gateway 3 and the server 4 receives detection values of a sensor comprised by the direction detecting unit 12 and the triaxial acceleration sensor 11 which are worn by the user and calculates the position information 143 from the detection values.

[Implementation Example Using Software]

The control blocks in the step-length calculating device (1, 1b, 1c), the portable terminal (2b, 2c), the gateway 3, and the server 4 may be implemented by logic circuits (hardware) formed in integrated circuits (IC chips) or may be implemented by software using CPUs (Central Processing Units).

In the latter case, the step-length calculating device (1, 1b, 1c), the portable terminal (2b, 2c), the gateway 3, and the server 4 each comprise a CPU for executing commands in a program that is software for realizing individual functions, a ROM (Read Only Memory) or a storage device (these are referred to as “recording media”) in which the above-described program and various types of data are recorded so as to be readable by a computer (or a CPU), a RAM (Random Access Memory) in which the above-described program is to be loaded, and so on. The computer (or the CPU) reads the above-described program from the recording medium and executes the program to thereby achieve an object of the present invention. “Non-transitory tangible media”, for example, a tape, a disc, a card, a semiconductor memory, a programmable logic circuit, and so on can be used as the above-described recording media. Also, the above-described program may be supplied to the computer over an arbitrary transmission medium (such as a communications network or a broadcast radio wave) through which the program can be transmitted. One aspect of the present invention can be implemented in the form of data signals embodied through electronic transmission of the above-described program and embedded in a carrier wave.

### SUMMARY

A step-length calculating device 1, 1b, 1c according to aspect 1 of the present invention is a step-length calculating device worn by a user and comprises: an acceleration sensor (a triaxial acceleration sensor 11); a height-difference calculating unit 1313, 1313a that calculates a height difference of the step-length calculating device at two particular time points by using vertical-direction accelerations of the step-length calculating device, the accelerations being detected by the acceleration sensor; and a step-length calculating unit 132 that calculates a step length of the user from the height difference and a leg length of the user.

According to the above-described configuration, the step length of the user is calculated from only the height difference of the step-length calculating device at two particular time points and a pre-set leg length of the user. Thus, the step length of the user can be calculated with simple processing.

In a step-length calculating device according to aspect 2 of the present invention, in aspect 1 described above, the acceleration sensor may be a triaxial acceleration sensor 11 and may comprise an acceleration calculating unit (a vertical-direction acceleration calculating unit 1311) that calculates vertical-direction accelerations from detection values of the acceleration sensor, and a relative-height calculating unit 1312 that calculates relative heights, which are heights of the step-length calculating device relative to a predetermined height, by integrating the vertical-direction accelerations; and the height-difference calculating unit may calculate the height difference of the step-length calculating device at two particular time points by using the relative heights.

According to the above-described configuration, the height difference of the step-length calculating device can be calculated from the relative heights, which are the heights of the step-length calculating device from a predetermined position.

A step-length calculating device according to aspect 3 of the present invention may be, in aspect 1 or 2 described above, the two particular time points may be a time point at which the height of the step-length calculating device reaches an upper-end peak and a time point at which the height of the step-length calculating device reaches a lower-end peak in an amplitude of variations in the height of the step-length calculating device in a predetermined period.

The possibility that the legs of the user align is high at the time point at which the height of the step-length calculating device reaches the upper-end peak in a predetermined period. Also, the possibility that the legs of the user are open and are both touching the ground is high at the time point at which the height of the step-length calculating device reaches the lower-end peak in the predetermined period.

Thus, according to the above-described configuration, the step length of the user can be calculated from a height difference between the height of the step-length calculating device in the state in which the legs of the user align and the height of the step-length calculating device in the state in which the legs of the user are open and both the feet touch the ground.

A step-length calculating device according to aspect 4 of the present invention may comprise, in aspect 1 or 2 described above, a walking-motion determining unit 1314a that determines a time point at which both feet in walking motion of the user align and a time point at which both the feet in the walking motion of the user touch the ground, in accordance with detection values detected by the acceleration sensor; and the two particular time points may be a time point at which both the feet align and a time point at which both the feet touch the ground in a predetermined period.

Thus, according to the above-described configuration, the step length of the user can be calculated from a height difference between the height of the step-length calculating device in the state in which the legs of the user align and the height of the step-length calculating device in the state in which the legs of the user are open and both the feet touch the ground.

In a step-length calculating device according to aspect 5 of the present invention, in any one of aspects 1 to 4 described above, the step-length calculating unit may calculate a larger step length for a larger leg opening of the user. According to the above-described configuration, it is possible to calculate the step length in accordance with the degree of leg opening of a user.

In a step-length calculating device according to aspect 6 of the present invention, in any one of aspects 1 to 5 described above, the step-length calculating unit may calculate a larger step length for a larger leg length of the user. According to the above-described configuration, it is possible to calculate the step length in accordance with the leg length of the user.

A step-length calculating device according to aspect 7 of the present invention may comprise, in any one of aspects 1 to 6 described above, a sensor (an angular velocity sensor 121, a geomagnetic sensor 122) that detects a walking direction of the user, and a motion-vector calculating unit 133 that calculates motion vectors for respective steps of the user in accordance with detection values of the sensor that detects the walking direction of the user and the calculated step length of the user. According to the above-described configuration, it is possible to calculate motion vectors for respective steps of a user. Thus, it is possible to generate information indicating movement of the user.

A step-length calculating device according to aspect 8 of the present invention may comprise, in aspect 7 described above, a position calculating unit 134 that calculates a position of the user by summing the motion vectors for the respective steps. According to the above-described configuration, it is possible to generate information indicating movement of the user from a particular time point or from a particular place.

A step-length calculating device 1b according to aspect 9 of the present invention may comprise, in aspect 7 described above, a transmitting unit 16b that transmits information indicating the motion vectors to external equipment (a portable terminal 2b). According to the above-described configuration, information indicating movement of the user can be transmitted to external equipment (for example, an indoor navigation device or the like).

A step-length calculating device 1c according to aspect 10 of the present invention may comprise, in aspect 8 described above, a transmitting unit 16c that transmits information indicating the position of the user to external equipment (a portable terminal 2c). According to the above-described configuration, information indicating movement of a user from a particular time point or a particular place can be transmitted to external equipment.

A portable terminal 2b according to aspect 11 of the present invention may comprise: a display unit 25b; a receiving unit 21b that receives, from an external step-length calculating device 1b, information indicating motion vectors for respective steps of a user; a position calculating unit 222b that calculates a position of the user by summing the motion vectors for the respective steps; and a display control unit (an image updating unit 223b) that displays, in accordance with the calculated position of the user, an image indicating the position of the user on the display unit.

According to the above-described configuration, it is possible to realize a navigation device and so on that display, to the user who wears the step-length calculating device 1b, the position of the user.

A position-information providing system 100 according to aspect 12 of the present invention include the step-length calculating device according to aspect 9; a gateway 3 that receives information indicating motion vectors for respective steps of a user from the step-length calculating device; a server 4 that communicates with the gateway; and an information terminal 5 that communicates with the server and that comprises a display unit. Any one of the gateway and the server may calculate a position of the user by summing the motion vectors for the respective steps, and the information terminal may receive information indicating the calculated position of the user and may display an image indicating the position of the user on the display unit in accordance with the information.

According to the above-described configuration, a user who is different from the user wearing the step-length calculating device can check the position and the trace of movement of the user wearing the step-length calculating device, while being at a place away from the place where the user wearing the step-length calculating device is located. Thus, it is possible to realize a traffic line management system for a factory and so on. Also, since the step-length calculating device calculates the motion vectors for respective steps, it is possible to reduce the amount of communication data in the system. Hence, it is possible to reduce power consumption for communication and the amount of processing of a server and so on.

A position-information providing system 100 according to aspect 13 of the present invention may include the step-length calculating device according to aspect 10; a gateway that receives information indicating a position of the user from the step-length calculating device; a server that communicates with the gateway; and an information terminal that communicates with the server and that comprises a display unit. The information terminal may receive information indicating the position of the user and may display an image indicating the position of the user on the display unit in accordance with the information.

According to the above-described configuration, it is possible to offer an advantage that is analogous to aspect 12. In addition, since the step-length calculating device calculates information indicating the position of the user which is obtained by summing the motion vectors for the respective steps, it is possible to reduce the amount of communication data in the system.

A control method for a step-length calculating device according to aspect 14 of the present invention is a step-length calculating device worn by a user and includes: a height-difference calculating step (S5, S12) of calculating a height difference of the step-length calculating device at two particular time points by using vertical-direction accelerations of the step-length calculating device, the accelerations being detected by an acceleration sensor comprised by the step-length calculating device; and a step-length calculating step (S6) of calculating a step length of the user from the height difference and a leg length of the user. According to the above-described configuration, it is possible to offer an advantage that is analogous to aspect 1.

The step-length calculating device, the portable terminal, the gateway, and the server according to the aspects of the present invention may be realized by computers, and in this case, a control program that causes the computers to realize the step-length calculating device, the portable terminal, the gateway, and the server by causing the computers to operate as individual units (software elements) comprised by the step-length calculating device, the portable terminal, the gateway, and the server and a computer-readable recording medium in which the control program is recorded are also fall within the category of the present invention.

The present invention is not limited to each embodiment described above, various changes are possible within the scope recited in the claims, and an embodiment obtained by appropriately combining the technical means respectively disclosed in the different embodiments is also encompassed by the technical scope of the present invention. In addition, new technical features can be formed by combining the technical means respectively disclosed in the embodiments.

### REFERENCE SIGNS LIST

1, 1b, 1c step-length calculating device
2b, 2c portable terminal (external equipment)
3 gateway
4 server
5 information terminal
11 triaxial acceleration sensor (acceleration sensor)
16c, 16b transmitting unit
21b receiving unit
100 position-information providing system
121 angular velocity sensor (sensor for detecting a walking direction)
122 geomagnetic sensor (sensor for detecting a walking direction)
132 step-length calculating unit
133 motion-vector calculating unit
134 position calculating unit
222b position calculating unit
223b image updating unit (display control unit)
1311 vertical-direction acceleration calculating unit (acceleration calculating unit)
1312 relative-height calculating unit
1313, 1313a height-difference calculating unit
S5, S12 height-difference calculating step
S6 step-length calculating step

1. A step-length calculating device worn by a user, the step-length calculating device comprising:
an acceleration sensor;
a height-difference calculating unit that calculates a height difference of the step-length calculating device at two particular time points by using vertical-direction accelerations of the step-length calculating device, the accelerations being detected by the acceleration sensor, and
a step-length calculating unit that calculates a step length of the user from the height difference and a leg length of the user.

2. The step-length calculating device according to claim 1,
wherein the acceleration sensor is a triaxial acceleration sensor;
wherein the step-length calculating device comprises an acceleration calculating unit that calculates vertical-direction accelerations from detection values of the acceleration sensor, and
a relative-height calculating unit that calculates relative heights, which are heights of the step-length calculating device relative to a predetermined height, by integrating the vertical-direction accelerations; and
wherein the height-difference calculating unit calculates the height difference of the step-length calculating device at two particular time points by using the relative heights.

3. The step-length calculating device according to claim 1,
wherein the two particular time points are a time point at which the height of the step-length calculating device reaches an upper-end peak and a time point at which the height of the step-length calculating device reaches a lower-end peak in an amplitude of variations in the height of the step-length calculating device in a predetermined period.

4. The step-length calculating device according to claim 1, comprising:
a walking-motion determining unit that determines a time point at which both feet in walking motion of the user align and a time point at which both the feet in the walking motion of the user touch the ground, in accordance with detection values detected by the acceleration sensor,
wherein the two particular time points are a time point at which both the feet align and a time point at which both the feet touch the ground in a predetermined period.

5. The step-length calculating device according to claim 1,
wherein the step-length calculating unit calculates a larger step length for a larger leg opening of the user.

6. The step-length calculating device according to claim 1,
wherein the step-length calculating unit calculates a larger step length for a larger leg length of the user.

7. The step-length calculating device according to claim 1, comprising:
a sensor that detects a walking direction of the user; and
a motion-vector calculating unit that calculates motion vectors for respective steps of the user in accordance with detection values of the sensor that detects the walking direction of the user and the calculated step length of the user.

8. The step-length calculating device according to claim 7, comprising:
a position calculating unit that calculates a position of the user by summing the motion vectors for the respective steps.

9. The step-length calculating device according to claim 7, comprising:
a transmitting unit that transmits information indicating the motion vectors to external equipment.

10. The step-length calculating device according to claim 8, comprising:
a transmitting unit that transmits information indicating the position of the user to external equipment.

11. A portable terminal comprising:
a display unit;
a receiving unit that receives, from an external step-length calculating device, information indicating motion vectors for respective steps of a user,
a position calculating unit that calculates a position of the user by summing the motion vectors for the respective steps; and
a display control unit that displays, in accordance with the calculated position of the user, an image indicating the position of the user on the display unit.

12. A position-information providing system including:
the step-length calculating device according to claim 9;
a gateway that receives information indicating motion vectors for respective steps of a user from the step-length calculating device;
a server that communicates with the gateway; and
an information terminal that communicates with the server and that comprises a display unit,
wherein any one of the gateway and the server calculates a position of the user by summing the motion vectors for the respective steps, and
the information terminal receives information indicating the calculated position of the user and displays an image indicating the position of the user on the display unit in accordance with the information.

13. A position-information providing system including:
the step-length calculating device according to claim 10;
a gateway that receives information indicating a position of the user from the step-length calculating device;
a server that communicates with the gateway; and
an information terminal that communicates with the server and that comprises a display unit, and
wherein the information terminal receives information indicating the position of the user and displays an image indicating the position of the user on the display unit in accordance with the information.

14. A control method for a step-length calculating device worn by a user, the control method including:
a height-difference calculating step of calculating a height difference of the step-length calculating device at two particular time points by using vertical-direction accelerations of the step-length calculating device, the accelerations being detected by an acceleration sensor comprised by the step-length calculating device; and
a step-length calculating step of calculating a step length of the user from the height difference and a leg length of the user.

15. (canceled)
